(19) United States
(12) Patent Application Publication
(10) Pub. No.: US 2009/0045655 A1
(43) Pub. Date: Feb. 19, 2009

(54) Multi-Panel Panoramic Roof Module

(75) Inventors: Michael T. Willard, Harrison Township, MI (US); Robert E. Fallis, III, Rochester, MI (US); Jan Just, Bloomfield Hills, MI (US)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Rochester Hills, MI (US)

(21) Appl. No.: 12/191,383

(22) Filed: Aug. 14, 2008

Related U.S. Application Data
(60) Provisional application No. 60/956,202, filed on Aug. 16, 2007.

(51) Int. Cl. B60J 7/047

(52) U.S. Cl. 296/217

(57) ABSTRACT

A retractable roof for a vehicle having a passenger compartment that is selectively covered by the retractable roof. A pair of roof rails define a plurality of tracks that support a plurality of rigid roof panels on opposite lateral sides of the rigid panels. An upper tailgate extends between a rear portion of the roof rails and is pivoted on a lower edge of the upper tailgate from a forward and upper orientation in a closed position to a horizontal position in the open position. In the closed position, the rigid panels are aligned to form a continuous roof and in the open position, the panels are vertically stacked below the upper tailgate.

### CROSS-REFERENCE TO RELATED APPLICATIONS

This application claims the benefit of U.S. provisional application Ser. No. 60/956,202 filed Aug. 16, 2007.

### BACKGROUND OF THE INVENTION

1. Field of the Invention

The present invention relates to a vehicle with a lamellar roof that is stored on the vehicle below a pivoting rear panel.

2. Background Art

Vehicles are designed to serve multiple functions. The multiple functions served by a vehicle may have different space and ergonomic requirements for the passenger compartment. One adaption of a passenger compartment may involve changing the configuration of the vehicle roof. On many vehicles, the roof is rigid in order to limit outside noise entering the passenger compartment. A rigid roof is difficult to reconfigure quickly and to store efficiently. A rigid roof may be divided into rigid lamellar sections. A lamellar section is formed by a plurality of plates, or lamella sections.

Some vehicle roofs have openings that allow the passenger compartment to be exposed to the wind and sunshine while driving during good weather. Small roof openings that are provided for sunroofs may easily incorporate self-storage because of their relative small size. Covers for larger openings above a vehicle passenger compartment are difficult to store in the space available in a vehicle and also tend to be relatively complex.

Occasionally, there is a need to carry bulky packages that may exceed the space available in an enclosed passenger compartment. Passenger compartment space may be expanded if the vehicle is provided with a system for removing a relatively large portion of the vehicle roof. With the vehicle roof substantially removed, the vehicle can carry larger objects in the manner of a pick-up truck. Storing a relatively large portion of the roof in a vehicle may be made more difficult if the roof system includes a top stack linkage that must be stored on the vehicle with the roof.

Some passengers may prefer a structural arrangement in which of the roof pillars and roof side members remain in place when a relatively large portion of the roof is removed. Retaining the roof side members also benefits the vehicle manufacturer because modular roof assembly methods made popular by unibody construction may still be practiced, resulting in relatively lower costs. Space for storage of large portions of the roof must be minimized because there are increasing demands for space inside vehicles to accommodate other features, such as passive and active restraints, electronic equipment, structural supports, and other vehicle body parts.

There is a need for a simple and effective roof system and method to store and/or deploy a rigid roof in a limited storage area. The roof system and storage method should provide ample structural integrity when the roof is stored. The roof system and method should also support relatively low cost manufacturing methods such as unibody construction.

### SUMMARY OF THE INVENTION

According to one aspect of the present invention, a vehicle is provided that has a passenger compartment which is selectively covered by a retractable roof that moves between a closed position and an open position. The vehicle comprises a pair of roof rails that each define a plurality of tracks that generally extend in a longitudinal vehicle direction from a windshield header to an upper edge of a tailgate. A plurality of rigid panels are connected by a pair of panel support members to at least one track on opposite lateral sides of the panel. An upper tailgate extends between a rear portion of the roof rails. The upper tailgate and rear portion of the roof rails are pivoted on a lower edge of the upper tailgate from a forward and upward orientation in the closed position to a horizontal position in the open position. The rigid panels are moved from the closed position in which the panels are aligned to form a continuous roof with the vehicle over the passenger compartment to the open position in which the panels are vertically stacked below the upper tailgate.

According to another aspect of the present invention, a retractable roof is provided for a vehicle that is comprised of a plurality of rigid roof panels that are arranged in a longitudinally extending row when the roof is in a closed position. The plurality of rigid roof panels are arranged in a vertical stack in an open position. Right and left roof panel guide tracks define a plurality of slots. A plurality of panel support members are provided on each of the rigid roof panels that are received in the slots of the guide tracks. An upper tailgate is arranged rearward and below the row of rigid roof panels when the roof is in the closed position. The vertical stack of roof panels is disposed below the upper tailgate in the closed position.

According to further aspects of the present invention, a front panel, a middle panel, and a rear panel are each moved in a pair of slots that are formed in the plurality of tracks in the pair of roof rails. A first pair of slots guides the front panel below the second pair of slots, the first and second pair of slots guide the front and middle panel below the third pair of slots, and the first, second and third pair of slots guide the front, middle and rear panels to a position between the upper tailgate and the passenger compartment.

According to another aspect of the invention, the upper tailgate is attached to a tailgate guide track member that is initially aligned with the plurality of tracks in the roof rails. The upper tailgate and the upper tailgate guide track members are pivoted with the upper tailgate on a lower rear edge. The tailgate guide track member retains first and second opposite lateral sides of the upper tailgate in both the open and closed positions.

According to other aspects of the invention, the front panel may be retracted to a position below another one of the rigid panels to provide a sun roof opening. The front and middle panels may be retracted to a position below the rear panel to provide an enlarged sun roof opening. The front, middle and rear roof panels may be retracted to a position between the upper tailgate and the passenger compartment to provide a full length sun roof opening. The rigid roof panels are attached to cables that are used in conjunction with drive units to extend and retract the roof panels between the closed and open positions.

These and other aspects of the present invention will be better understood in view of the attached drawings and the following detailed description of the illustrated embodiment.

### BRIEF DESCRIPTION OF THE DRAWINGS

FIG. 1 is a fragmentary perspective view of the roof and passenger compartment of a vehicle made in accordance with the present invention;

FIG. 2 is a cross-sectional view taken along the line 2-2 in FIG. 1;

FIG. 3 is a diagrammatic view of a lamellar roof made according to the present invention;

FIG. 4 is a fragmentary transverse cross-sectional view of the tracks, followers, and roof panels of a lamellar roof made according to the present invention;

FIGS. 5A-5F illustrate the position of the lamellar roof as it is moved from an extended position in FIG. 5A in a series of steps to a fully retracted position in FIG. 5F;

FIG. 6 is a fragmentary cross-sectional view showing the roof in the stowed position; and

FIG. 7 is a fragmentary perspective view of the drive motors that drive the roof panels and also illustrates the cylinder drives that move the upper tailgate and stowed retractable roof panels between their extended and retracted positions.

### DETAILED DESCRIPTION OF THE PREFERRED EMBODIMENT(S)

Reference will now be made in detail to embodiments of the present invention known to the inventors. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art how to implement the present invention.

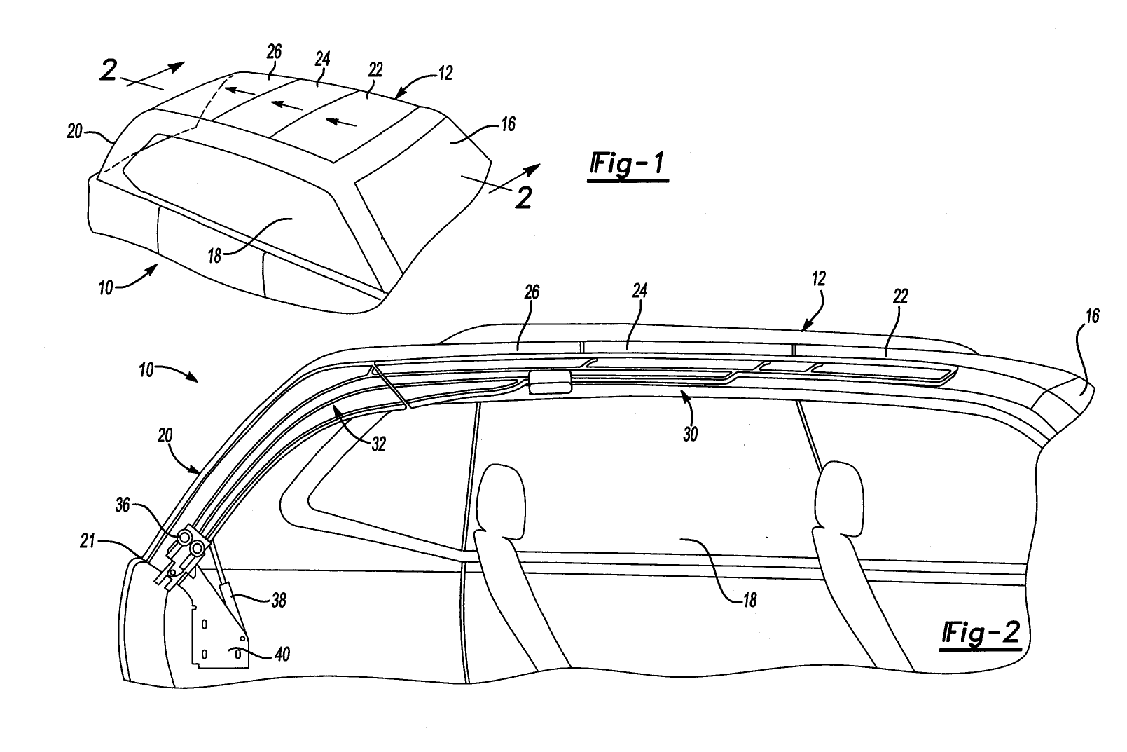

Referring to FIG. 1, the vehicle 10, for example an SUV, is provided with a lamellar roof generally indicated by reference numeral 12. The roof 12 extends from a windshield 16 above and between side window areas 18 to an upper tailgate 20. The upper tailgate 20 may also be characterized as a back light assembly or fast back depending upon vehicle styling. The upper tailgate 20 has a lower edge 21.

The lamellar roof 12 includes a front roof panel 22 that is disposed immediately in front of a middle roof panel 24. A rear roof panel 26 is located immediately rearward of the middle roof panel 24.

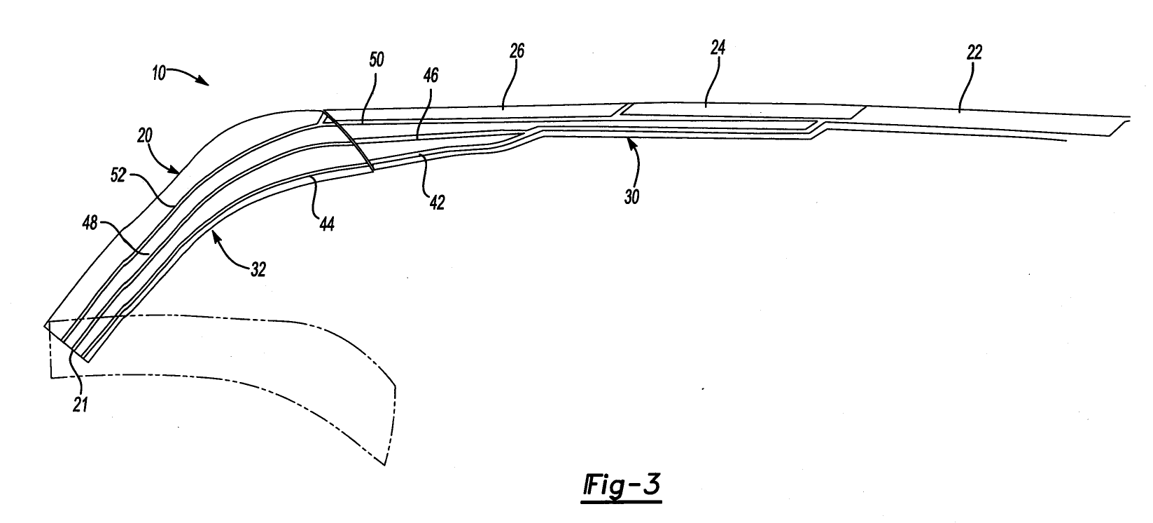

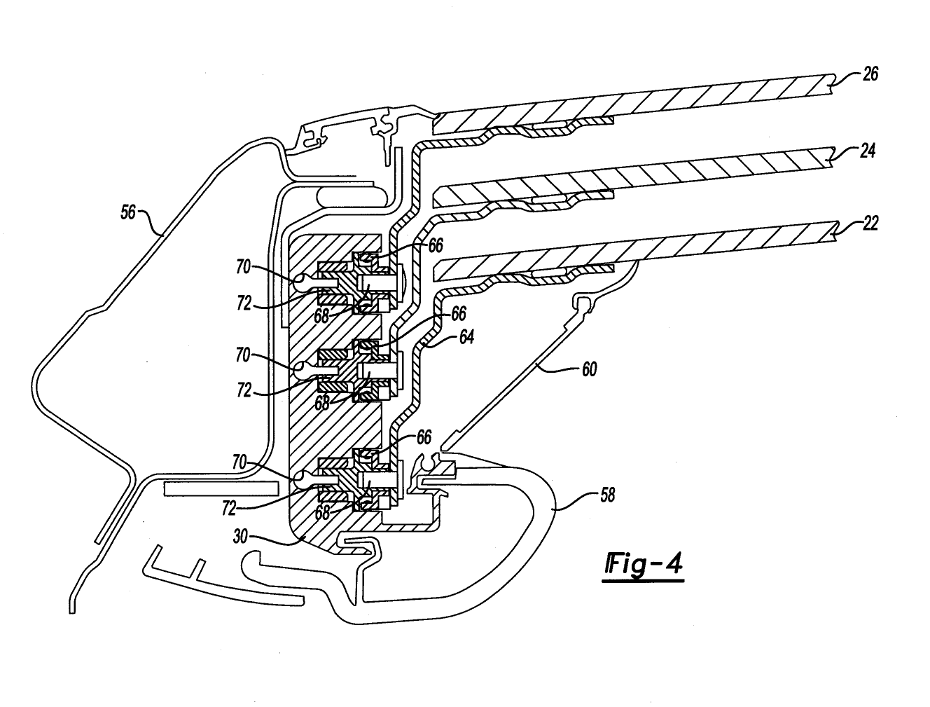

Referring to FIGS. 2 and 3, the lamellar roof 12 for the vehicle 10 is shown in greater detail. The roof 12 is shown with the front, middle, and rear roof panels 22, 24, 26 in their closed position. Also shown in FIG. 2 is a roof guide track member 30 that is provided generally below the roof 12 and above the side window area 18. The roof guide track member 30 is aligned with a tailgate guide track member 32. The structure of the guide track members 30, 32 will be described more specifically below.

A plurality of drive units 36 are provided near the lower edge 21 of the upper tailgate 20 to extend and retract the roof panels 22, 24, 26. The drive units 36 are similar to sunroof drive motors and for brevity will not be described in detail.

A power cylinder 38 is provided for raising and lowering the upper tailgate 20 which is mounted to a pivot bracket 40. The upper tailgate 20 is driven by the power cylinder 38 between a raised position shown in FIG. 2 to a lowered position. The power cylinder 38 may be a hydraulic or pneumatic cylinder.

Referring to FIG. 3, a front panel guide track 42 is provided on track member 30 that is aligned with the front panel guide track 44 of the tailgate guide track member 32. The front roof panel 22 when retracted drops down into the front panel guide track 42 and is moved rearwardly until it enters the front panel guide track 44. Similarly, a middle panel guide track 46 is provided in the roof track guide member 30. A middle panel guide track 48 is provided in the tailgate guide track member 32. When the middle roof panel 24 is retracted, the panel 24 drops into the middle panel guide track 46 and is moved rearwardly until it is received in the middle panel guide track 48. A rear panel guide track 50 is provided in the roof guide track member 30. A rear panel guide track 52 is provided in the tailgate guide track member 32. The rear roof panel 26 is retracted by initially shifting downwardly into the rear panel guide track 50 and then is moved rearwardly and downwardly into the rear panel guide member 52.

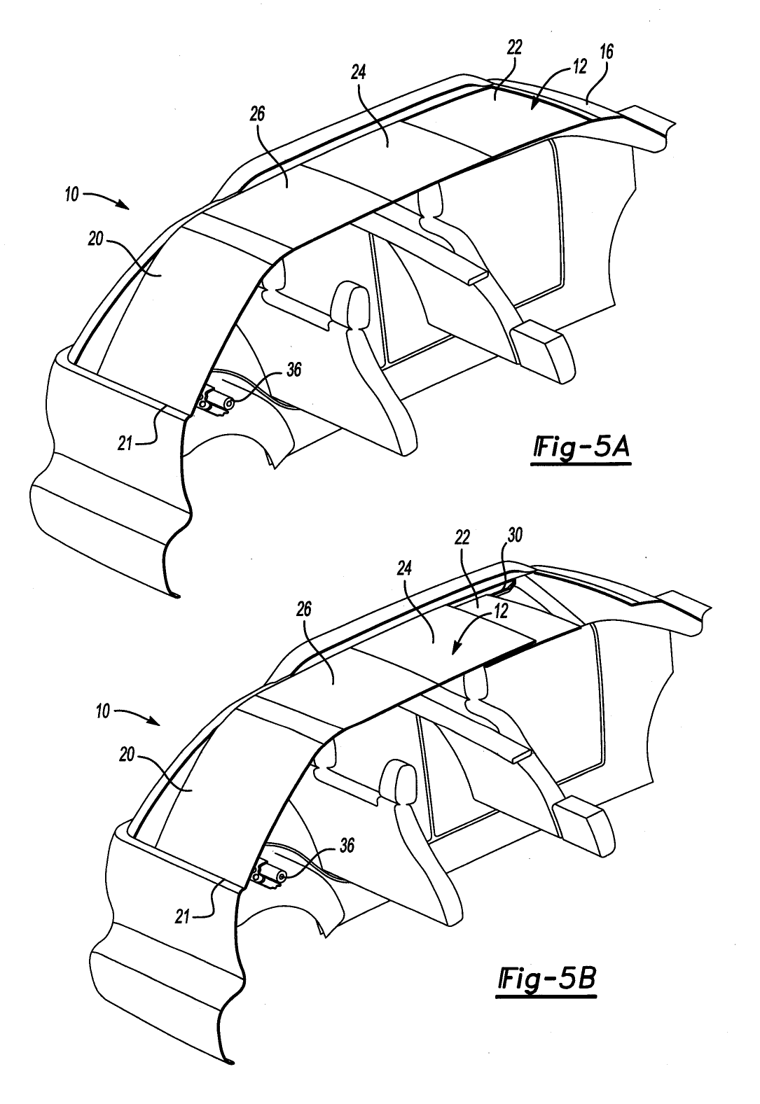

Referring now to FIG. 4, the roof panel brackets and follower structures are shown in conjunction with the guide tracks. FIG. 4 is a cross-section taken through the roof rail 56 on one side of the vehicle. A trim panel 58 that may be provided in a wide variety of shapes and configurations finishes the inner lower area of the roof. A fascia panel 60 is provided to conceal the functional parts of the lamellar roof 12.

Each of the roof panels 22, 24, 26 is connected by a panel support member 64 which extends downwardly and outwardly from the panels to a roller 66 that is received in one of the respective guide tracks, or slots. The roller 66 is rotatably secured to a pin 68. Pin 68 connects the panel support member 64 to the roller 66. A cable passageway 70 is also shown in FIG. 4 that receives a cable (not shown in FIG. 4) that is used to move each of the roof panels 22, 24, 26 between their extended and retracted positions as will be more fully described below. A follower body 72 is provided to link the cable that is received in the cable passageway 70 to the pin 68 and roller 66.

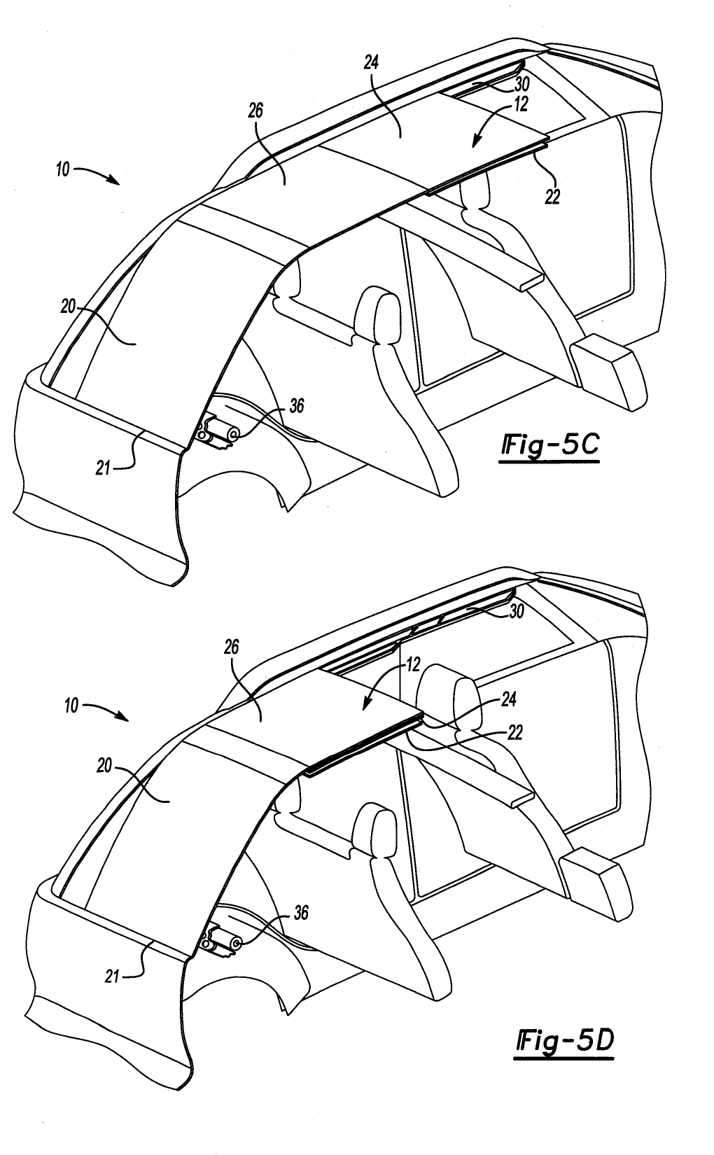

Retraction of the roof will be described with reference to FIGS. 5A-5F. In FIG. 5A, the roof 12 is shown in its fully extended position with the front roof panel 22 disposed between the windshield 16 and the middle roof panel 24. The middle roof panel 24 is provided between the front roof panel 22 and the rear roof panel 26. The roof panels in their extended position are generally coplanar to provide a smooth and continuous roof 12. The upper tailgate 20 extends downwardly and rearwardly from the rear edge of the rear roof panel 26. Stated in another way, the upper tailgate 20 extends upwardly and forwardly from a lower edge. Drive units 36 are also shown in FIG. 5A that are used to operate the roof panels 22, 24, 26.

Referring to FIG. 5B, the roof 12 is shown partially retracted with the front roof panel 22 dropping down into the roof guide track member 30 below the middle roof panel 24. The front roof panel 22 is moved by the cables that connect the roof panel 22 to its associated drive unit 36.

Referring to FIG. 5C, the front roof panel 22 is shown disposed directly below the middle roof panel 24. The retraction cycle may be stopped at this point to provide a sunroof-like opening over the front seat passengers. The middle roof panel 24 has not yet begun to be retracted in this position.

Referring to FIG. 5D, the front roof panel 22 is shown disposed below the middle roof panel 24 and below the rear roof panel 26. The front and middle roof panels 22, 24 have been moved rearwardly as guided by the roof guide track member 30. In this position, an enlarged opening is provided over the front seat passengers and at least partially over the second row passengers. Retraction of the roof can be stopped at this point to provide a partially opened roof or may continue as will be described below.

Referring to FIG. 5E, the retraction cycle has now continued to a point where the roof panels 22, 24, 26 are now retracted into the tailgate guide track member 32 below and in front of the upper tailgate 22. At this position, each of the drive units 36 associated with each of the roof panels 22, 24, 26 have been fully retracted. The retraction cycle may be stopped at this point to provide a large sunroof-type opening extending the full length of the roof above all of the passengers in the vehicle. Otherwise, the retraction cycle may continue as described below.

Referring to FIG. 5F, the roof 12 is shown in its fully retracted position. In this position, the upper tailgate 20 is pivoted forwardly on its rear edge on the pivot bracket 40 (not shown in FIG. 5F) as previously described. The front roof panel 22 is stacked below the middle roof panel 24, the rear roof panel 26, and the upper tailgate section 20. The upper tailgate section 20 has been pivoted to a generally horizontal orientation and fits behind the second row passenger seat. The tailgate guide track member 32 is moved out of alignment relative to the roof guide track member 30 and pivots with the upper tailgate 20 as shown.

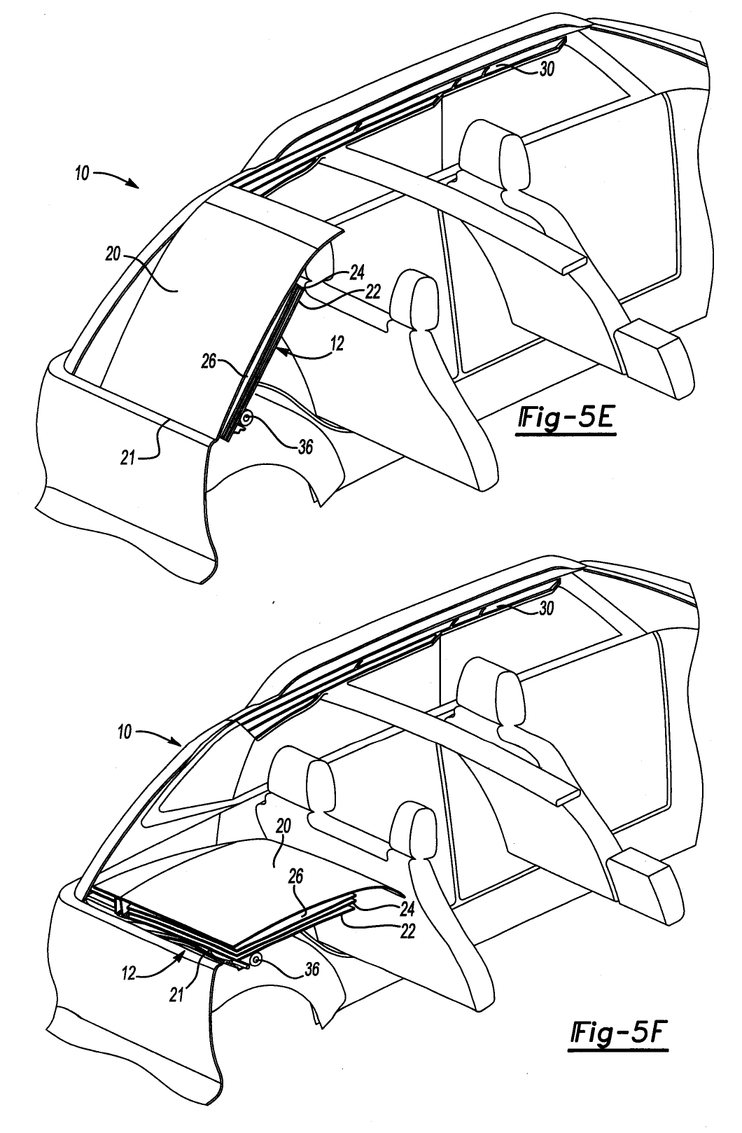

Referring now to FIG. 6, the roof 12 is shown in its fully retracted position behind the rear seat. The roof 12 is supported on the pivot bracket 40 stacked as previously described with the upper tailgate 20 in a horizontal orientation and with the rear roof panel 26, middle roof panel 24, and front roof panel 22 stacked below the upper tailgate 20. In this position, the power cylinder 38 has pivoted the upper tailgate 20 to its horizontal position on the pivot bracket 40. The tailgate guide track member 32 has also been pivoted with the upper tailgate 20 and is no longer aligned with the roof guide track 20. The upper tailgate 20 is disposed between the tailgate guide track members 32 in both the open and closed positions.

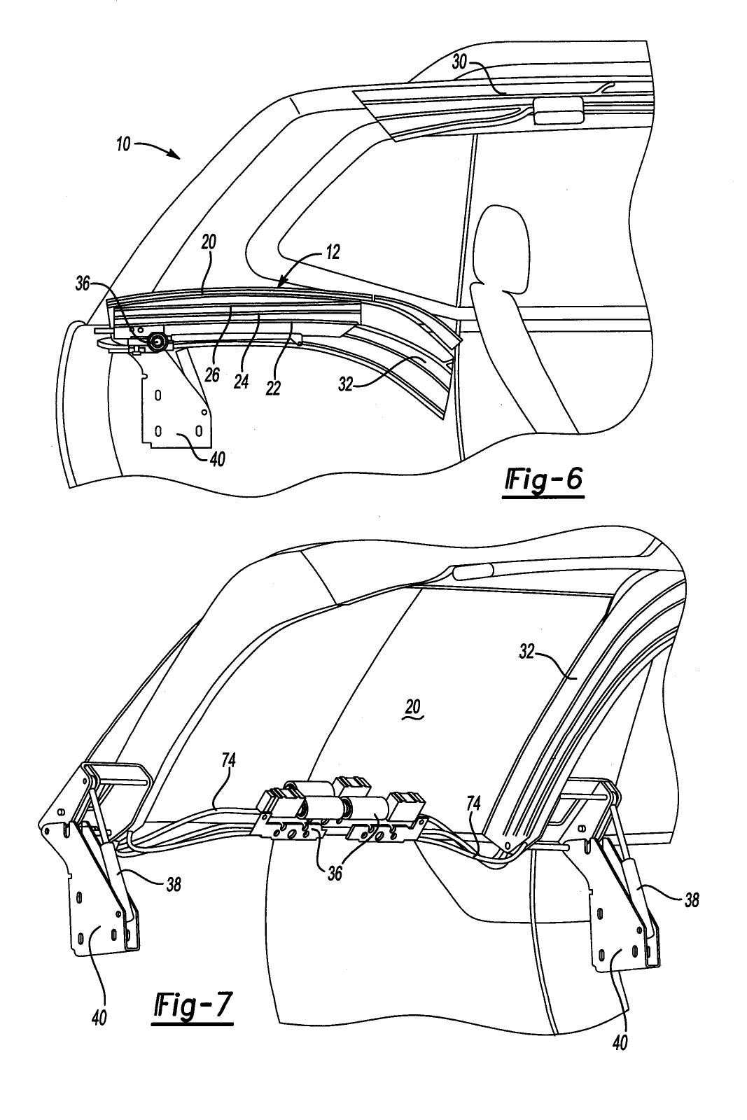

Referring to FIG. 7, the upper tailgate 20, or back light assembly, is shown with the roof 12 in its extended position. The drive units 36 are used to move the roof panel and are located at rear/lower portion of the upper tailgate 20. The drive units 36 act through a plurality of cables 74 to move the roof panels between their extended and retracted positions. The power cylinders 38 on both sides of the upper tailgate 20 are extended to place the upper tailgate 20 in its raised position. The upper tailgate 20 is pivotally connected to the pivot brackets 40 that are located at or near the lower edge 21 of the upper tailgate 20.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle having a passenger compartment that is selectively covered by a retractable roof that is movable between a closed position and an open position, the vehicle comprising:
a pair of roof rails, each roof rail defining a plurality of tracks that generally extend in a longitudinal vehicle direction from a windshield header area to an upper edge of a tailgate;
a plurality of rigid panels connected by a pair of panel support members to at least one track on opposite lateral sides of the panels;
an upper tailgate extends between a rear portion of the roof rails, the upper tailgate and rear portion of the roof rails are pivoted on a lower edge of the upper tailgate from a forward and upward orientation in the closed position to a horizontal position in the open position; and
wherein the rigid panels are moved from the closed position in which the panels are aligned to form a continuous roof for the vehicle over the passenger compartment to the open position in which the panels are vertically stacked below the upper tailgate.

2. The vehicle of claim 1 wherein the plurality of tracks comprise a plurality of pairs of slots, and wherein the plurality of panels comprise a front panel, a middle panel and a rear panel, wherein the front panel is moved in a first pair of slots that extend from the windshield header to the rear portion of the roof rails, the middle panel is moved in a second pair of slots that extend from a rear edge area of the front panel to the rear portion of the roof rails, and the rear panel is moved in a third pair of slots that extend from a rear edge area of the middle panel to the rear portion of the roof rails.

3. The vehicle of claim 2 wherein the first pair of slots guides the front panel below the second pair of slots, the first and second pair of slots guide the front and middle panels below the third pair of slots, and the first, second and third pair of slots guide the front, middle and rear panels to a position between the upper tailgate and the passenger compartment.

4. The vehicle of claim 1 wherein the upper tailgate is attached to a tailgate guide track member that is initially aligned with the plurality of tracks in the roof rails, wherein the upper tailgate and the tailgate guide track members are pivoted with the upper tailgate on a lower rear edge.

5. The vehicle of claim 4 wherein the tailgate guide track member retains first and second opposite lateral sides of the upper tailgate in both the open and closed positions.

6. The vehicle of claim 1 wherein one of the rigid panels is a front panel that may be retracted to a position below another one of the rigid panels which comprises a middle panel to provide a sunroof opening over the passenger compartment.

7. The vehicle of claim 6 wherein the front and middle panels may be retracted to a position below yet another one of the rigid panels which comprises a rear panel to provide an enlarged sunroof opening that is larger than and includes the sunroof opening.

8. The vehicle of claim 7 wherein the front, middle and rear roof panels may be retracted to a position between the upper tailgate and the passenger compartment to provide a full length sunroof opening that is larger than and includes the enlarged sunroof opening.

9. The vehicle of claim 1 wherein the plurality of rigid roof panels are each attached to one of a plurality of cables on a first end, and a plurality of drive units are attached to a second end of each one of the cables, wherein the drive units act upon the cables to retract the roof panels as the roof panels are moved from the closed position and the open position and the drive units act upon the cables to extend the rigid roof panels as the roof panels are moved from the open position to the closed position.

10. The vehicle of claim 1 wherein the panel support members each further comprise a roller that is attached to the panel support member by a pin, each of the pins being received in one of the tracks.

11. A retractable roof for a vehicle comprising:
a plurality of rigid roof panels that are arranged in a longitudinally extending row when the roof is in a closed position, and that are arranged in a vertical stack in an open position;
right and left roof panel guide tracks define a plurality of slots;
a plurality of panel support members are provided on each of the rigid roof panels that are received in the slots of the guide tracks; and
an upper tailgate is arranged rearward and below the row of rigid roof panels when the roof is in the closed position, and wherein the vertical stack of roof panels is disposed below the upper tailgate in the open position.

12. The retractable roof of claim 11 wherein the plurality of panels comprise a front panel, a middle panel and a rear panel, wherein the front panel is received in a first pair of the slots that extend from the windshield header to the rear portion of the roof rails, the middle panel is received in a second pair of the slots that extend from a rear edge area of the front panel to the rear portion of the roof rails, and the rear panel is received in a third pair of slots that extend from a rear edge area of the middle panel to the rear portion of the roof rails.

13. The retractable roof of claim 12 wherein the first pair of slots guides the front panel below the second pair of slots, the first and second pair of slots guide the front and middle panels below the third pair of slots, and the first, second and third pair of slots guide the front, middle and rear panels to a position between the upper tailgate and the passenger compartment.

14. The retractable roof of claim 11 wherein the upper tailgate is attached to a tailgate guide track member that is initially aligned with the plurality of slots defined by the roof panel guide tracks, wherein the upper tailgate and the tailgate guide track members are pivoted with the upper tailgate on a lower rear edge.

15. The retractable roof of claim 14 wherein the tailgate guide track member retains first and second opposite lateral sides of the upper tailgate in both the open and closed positions.

16. The retractable roof of claim 11 wherein one of the rigid panels is a front panel that may be retracted to a position below another one of the rigid panels which comprises a middle panel to provide a sunroof opening over the passenger compartment.

17. The retractable roof of claim 16 wherein the front and middle panels may be retracted to a position below yet another one of the rigid panels which comprises a rear panel to provide an enlarged sunroof opening that is larger than and includes the sunroof opening.

18. The retractable roof of claim 17 wherein the front, middle and rear roof panels may be retracted to a position between the upper tailgate and the passenger compartment to provide a full length sunroof opening that is larger than and includes the enlarged sunroof opening.

19. The retractable roof of claim 11 wherein the plurality of rigid roof panels are each attached to one of a plurality of cables on a first end, and a plurality of drive units are attached to a second end of each one of the cables, wherein the drive units act upon the cables to retract the roof panels as the roof panels are moved from the closed position and the open position and the drive units act upon the cables to extend the rigid roof panels as the roof panels are moved from the open position to the closed position.

20. The retractable roof of claim 11 wherein the panel support members each further comprise a roller that is attached to the panel support member by a pin, each of the pins being received in one of the slots.
